(19) United States
(12) Patent Application Publication
(10) Pub. No.: US 2024/0403127 A1
(43) Pub. Date: Dec. 5, 2024

(54) SYSTEM AND METHOD FOR REAL-TIME AFFINITY-BASED PEER-TO-PEER DISTRIBUTION WITH PRIORITIZED REQUIREMENTS MATCHING AND ALLOCATION

(71) Applicant: Samaritan Ministries, Peoria, IL (US)

(72) Inventors: Bryan D Phillips, Peoria, IL (US); David B Jackson, Peoria, IL (US)

(21) Appl. No.: 18/676,518

(22) Filed: May 29, 2024

Related U.S. Application Data
(60) Provisional application No. 63/469,532, filed on May 29, 2023.

(51) Int. Cl. G06F 9/50

(52) U.S. Cl. CPC G06F 9/5038

(57) ABSTRACT

An allocation computer may receive and store requirements in the peer-to-peer affinity-based distribution system. The allocation computer may generate from the received requirements, a prioritized queue of the received requirements, wherein the prioritized queue is generated by assigning weights to affinity indicators present in the received requirements. A plurality of fulfilment devices among the user devices, that are ready to transfer resources are identified. Each fulfilment device is associated with multiple affinity indicators. An allocation computer may for fulfilling a first requirement in the prioritized queue, match affinity indicators of a first fulfilment device with the affinity indicators present in the first requirement. The affinity matching is performed iteratively for each affinity indicators of the first fulfilment device. Resources from the first fulfilment device may be allocated to requesting device.

### CROSS-REFERENCE TO RELATED APPLICATIONS

This application claims the benefit of, and priority to U.S. Patent Appl. No. 63/469,532, titled, “SYSTEM AND METHOD FOR AFFINITY-BASED UNIT EXCHANGE FOR A PLURALITY OF USER DEVICES” filed on May 29, 2023, the entire specification of which is incorporated herein by reference.

### BACKGROUND OF THE INVENTION

### Field of the Art

The disclosure relates to the field of peer-to-peer distribution systems, and more particularly to the field of affinity-based allocation.

### SUMMARY OF THE INVENTION

In some aspects, the techniques described herein relate to a real-time peer-to-peer affinity-based resource allocation system. The system includes an allocation computer with a memory, a processor, and a plurality of programming instructions stored in the memory. When executed by the processor, the instructions cause the processor to: establish a peer-to-peer network connection with a plurality of user devices; receive and store resource requests from requesting devices among the user devices via the peer-to-peer network during a collection timeframe, where each requesting device is associated with affinity indicators; generate a prioritized queue of the resource requests by applying a weighted prioritization algorithm to the affinity indicators; identify provider devices among the user devices that are available to provide resources, where each provider device is associated with affinity indicators. To fulfill the highest priority resource request, the system: iteratively compares affinity indicators of each provider device with those of the requesting device using a matching algorithm; allocates resources from a first provider device to the requesting device based on the affinity matching, triggering a secure transfer of resources via the peer-to-peer network; monitors the transfer status; and updates the prioritized queue based on transfer completion within a predefined timeframe.

In some aspects, the techniques relate to a system where the allocation computer: determines if the resources from the first provider device are insufficient to fulfill the highest priority request; if insufficient, identifies a second provider device with matching affinity indicators using the iterative comparison; splits the resource allocation between the first and second provider devices; and securely allocates resources from both provider devices to the requesting device via the peer-to-peer network.

In some aspects, the techniques relate to a system where the iterative comparison of affinity indicators includes: determining if the set of affinity indicators of the first provider device, ordered by priority, matches the affinity indicators of the requesting device; if a mismatch, removing the lowest priority affinity indicator from the first provider device's set; updating the set of affinity indicators of the first provider device; and repeating the comparison with the updated set until a match is found or all indicators are exhausted.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a block diagram illustrating an exemplary hardware architecture of a computing device used in an embodiment of the invention;

FIG. 2 is a block diagram illustrating an exemplary logical architecture for a client device, according to an embodiment of the invention;

FIG. 3 is a block diagram showing an exemplary architectural arrangement of clients, servers, and external services, according to an embodiment of the invention;

FIG. 4 is another block diagram illustrating an exemplary hardware architecture of a computing device used in various embodiments of the invention;

FIG. 5A depicts the environment of allocation computer for prioritizing requirements requests and allocating resources, according to an embodiment of the invention;

FIG. 5B is a flowchart illustrating a method for allocating units in peer-to-peer network, according to an embodiment of the invention;

FIG. 6 depicts an example illustration of peer-to-peer allocation system, according to an embodiment of the invention;

FIG. 7 illustrates affinity indicators of fulfilment devices that are used for affinity matching for a requirement request, according to an embodiment of the invention;

FIG. 8A is a flowchart illustrating a method for selecting fulfilment devices and allocating resources to requirements between user devices, according to an embodiment of the invention;

FIG. 8B illustrates information used by allocation engine to allocate fulfilment devices for requirements, according to an embodiment of the invention;

FIG. 9 is a flowchart illustrating a method for affinity matching used for resource allocation, according to an embodiment of the invention;

FIG. 10 is a flowchart illustrating a method for allocating resources for a requirement, according to an embodiment of the invention;

FIG. 11 depicts a flowchart of a method for rank order-based weight assignment for generation of prioritized queue, according to an embodiment of the invention and

FIG. 12 illustrates an example of requirements received from requesting devices being prioritized by the prioritizer, according to an embodiment of the invention.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical, and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. On the contrary, a variety of optional components may be described to illustrate a wide variety of possible embodiments of one or more of the inventions and to fully illustrate one or more aspects of the inventions. Similarly, although process steps, method steps, algorithms, or the like may be described in sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of the described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the inventions(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of more than one device or article.

The functionality or features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code that include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by computer programming instructions stored in memory. Such network devices may have multiple network interfaces that may be configured or designed to utilize different types of network communication protocols. A general architecture for some of these machines may be described herein to illustrate one or more exemplary means by which a given unit of functionality may be implemented. According to specific embodiments, at least some of the features or functionalities of the various embodiments disclosed herein may be implemented on one or more specifically designed computers associated with one or more networks, such as, for example, an end-user computer system, a client computer, a network server or other server system, a mobile computing device (e.g., tablet computing device, mobile phone, smartphone, laptop, or other appropriate computing devices), a consumer electronic device, a music player, or any other suitable electronic device, router, switch, or other suitable devices, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

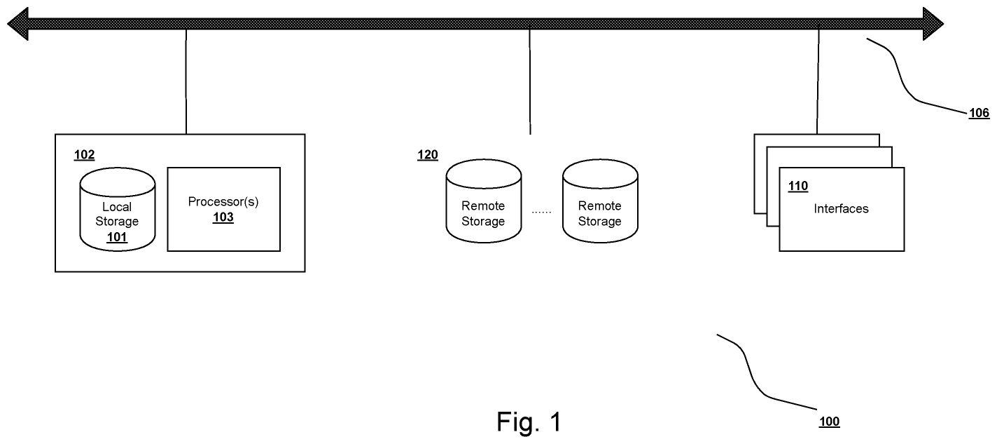

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interface 110 is provided as network interface cards (NICs).

Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interface 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control the execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art about personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid-state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

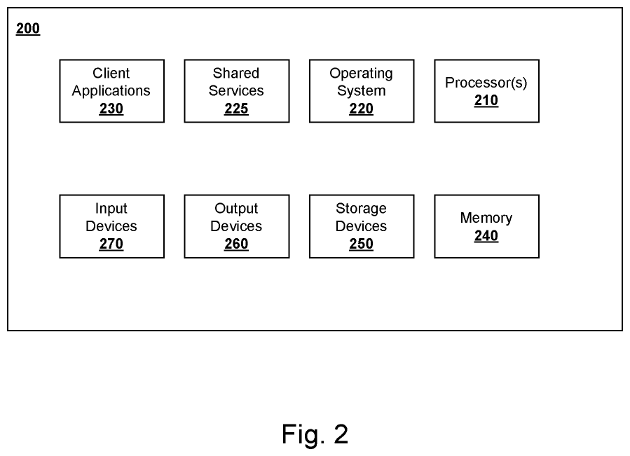

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carries out one or more functions or applications of embodiments of the invention, such as, a client application 230. Processors 210 may carry out computing instructions under the control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more allocated services 225 may be operable in system 200 and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example, to run the software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

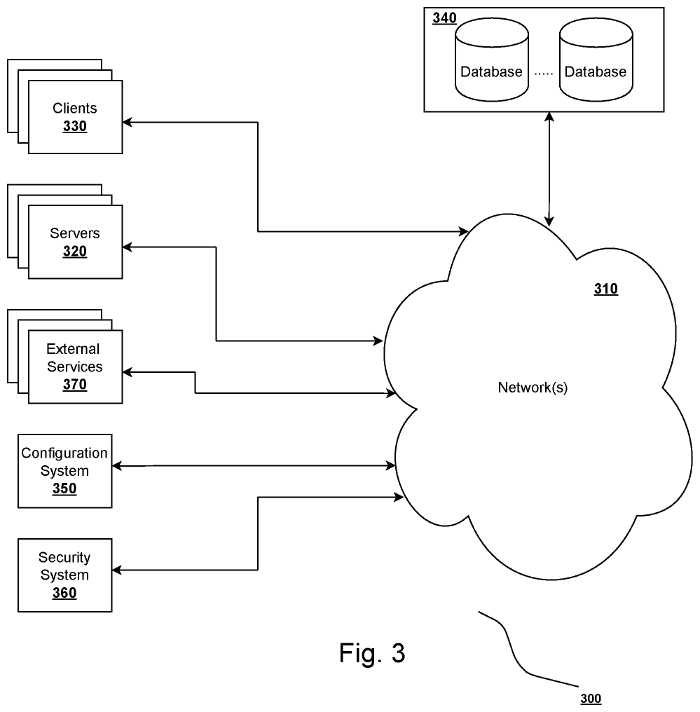

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of particular enterprises or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google Bigtable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each is generally associated with any IT or web systems. It should be understood by one having ordinary skill in the art that any configuration or security subsystems known in the art now or in the future may be used in conjunction with embodiments of the invention without limitation unless a specific security 360 or configuration system 350 or approach is specifically required by the description of any specific embodiment.

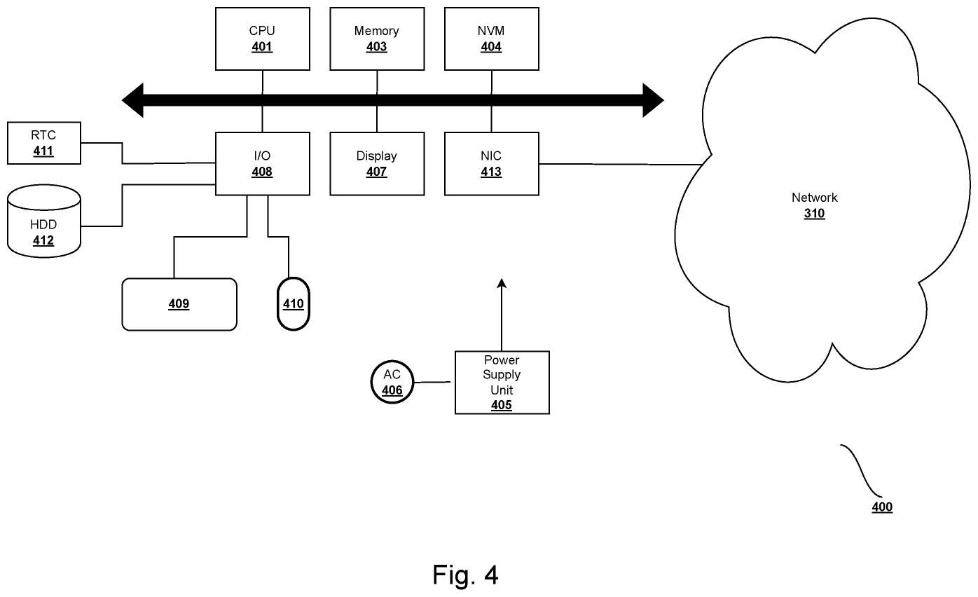

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, non-volatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but do not apply to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

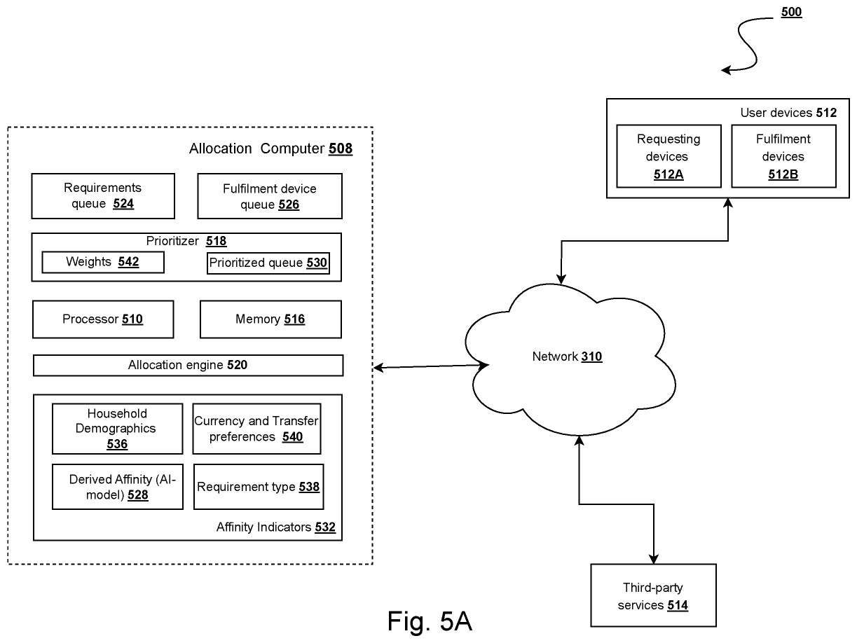

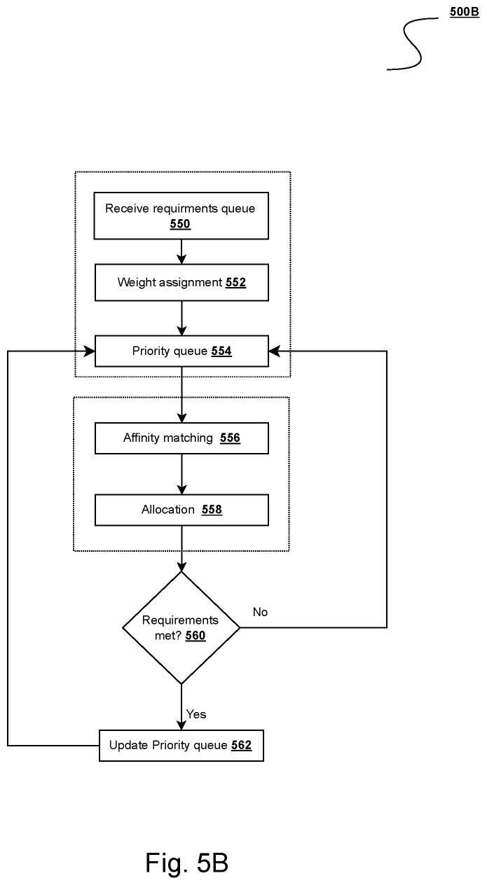

FIG. 5A depicts the environment of allocation computer 508 for prioritizing requirement requests and allocating resources, according to an embodiment of the invention. In an embodiment, allocation computer 508 may be run by an allocation algorithm that computes an allocation arrangement for a plurality of user devices 512. According to the embodiment, allocation computer 508 may comprise on or more processors 510, memory 516, and a plurality of programming instructions, the plurality of programming instructions stored in memory 516 that when executed by one or more processors 510 cause the processor 510 to allocate resources received from the user devices 512 to requirements associated with one or more other user devices 512. Allocation computer 508 further comprises prioritizer 518, allocation engine 520, requirements queue 524, Fulfilment device queue 526, prioritized queue 530, and affinity-based parameters 532.

Allocation computer 508 may be in communication with a plurality of user devices 512 and third-party services 514 over network 310. User devices 512 may be similar to client 330 as described in FIG. 3. User devices 512 may be associated with devices that are comprised within a distribution arrangement. In an embodiment, allocation computer 508 may receive a ready-to-allocate indication from one or more user devices 512 that may be referred to as fulfilment devices 512B. Allocation computer 508 receiving requirements from one or more user devices 512 may be referred to as requesting devices 512A. It should be understood that each user device among the user devices 512 may perform the role of a fulfilment device 512B and/or a requesting device 512A at any given point in time.

Third-party service 514 may be service providers that support allocation and or transfer of resources in a peer-to-peer distribution. For example, third-party service provider 514 may be associated with group-based healthcare contributions and e-services that support the transfer of resources electronically. In another embodiment, third-party service 514 may be associated with charities, education institutions, organizations, and groups of enterprises that a user device is associated with. In other embodiments, resources may be a portion (in some respects, the at least portion may be represented in units) of computational resources comprising data resources, digital assets, services, virtual resources, network resources, and the like. In this case, a transfer of units representing computation resources may refer to an allocation of those resources to another device. Accordingly, the term transfer may be seen as transferring an ability to use the allocated resource rather than transferring the actual resource. In some embodiments, each resource or portion of an allocation may comprise of a combination of, for example, computational resources and digital assets. For example, a resource allocation may include a specific amount of processing power, memory, storage, and access to specific data sets or software licenses.

Computational resources may include, but not limited to, processing power (CPU cycles), memory (RAM), storage (disk space), network bandwidth, and the like. Data resources may include data sets, data streams, data models, data analytics results, and the like. Digital assets may include: files (documents, images, videos, etc.), digital certificates, encryption keys, access tokens, and the like. Services may include: Software licenses, application programming interface (API) access, cloud computing services, microservices, and the like. Virtual resources may include: virtual machines (VMs), containers, virtual private networks (VPNs), virtual storage volumes, and the like. Network resources may include: network nodes, network connections, network protocols, network services (e.g., DNS, DHCP), and the like.

Requirements queue 524 may be a list of requirements received, by allocation computer 508 from one or more user devices 512 for a specific period. Each requirement request may be given a unique requirement identification number and may be associated with a requesting device 512A. Requirement requests received may further include a description of the requirement, associated user number, associated user ID identifying a particular associated user within the arrangement having a requirement, and, in some embodiments, a quantity associated with the requirement. In an embodiment, requirements for a current period may be loaded into a requirements queue 524. During this period, a total amount that is allocatable may be calculated. In some embodiments, a requirement may be prorated by a predetermined percentage, which, in some embodiments, may happen when a total amount of requirements exceeds a total amount of resources, in turn affecting a total amount that is allocatable.

In some embodiments, the resource allocation system may handle a wide range of resource types, including computational resources (e.g., processing power, memory, storage), data resources (e.g., datasets, data streams, analytics results), digital assets (e.g., files, certificates, access tokens), and more. These resources may identified and represented within the system in a uniform manner, allowing for flexible allocation and sharing across diverse provider and requesting devices. The expanded definition of resources enables the system to accommodate a broad spectrum of use cases and technical domains, from distributed computing to data analysis and beyond.

Prioritizer 518 may be configured to generate a prioritized queue 530 for requirements received, by allocation computer 508, at an allocation portal. In an embodiment, prioritizer 518 is an algorithm that assigns priorities to requirements in the requirements queue 524 based on different criteria. In a preferred embodiment, prioritizer 518 may be a critical component of the resource allocation system that determines the order in which resource requests should be processed and fulfilled. It employs a sophisticated prioritization algorithm that considers multiple factors to assign weights 542 to each resource request in the queue 524. These factors include the type and criticality of the requested resources, with higher weights assigned to scarce or essential resources such as high-performance computational assets or other computations elements. The algorithm may also evaluate the availability and capacity of resources across the network of provider devices, giving higher priority to requests that can be efficiently fulfilled by a larger pool of providers. Additionally, the prioritizer may take into account resource dependencies and compatibility, ensuring that requests with all required resources readily available are given precedence. Quality of service requirements and performance metrics are also key considerations, with the prioritizer assigning higher weights to requests that have strict latency, throughput, or reliability demands. Furthermore, the algorithm may promote fairness by considering the resource sharing history of both requesting and provider devices, rewarding user devices who have consistently contributed high-quality resources to the peer-to-peer network. By comparing these weighted parameters, the prioritizer generates a dynamically updated prioritized queue 530, ensuring that the most critical and feasible resource requests are processed first, while also maintaining a balance between efficiency and fairness in the resource allocation process.

The prioritizer may employs a multi-factor prioritization algorithm that assigns weights to resource requests based on a comprehensive set of attributes. These attributes include resource type and criticality, with higher weights given to scarce or essential resources. The algorithm also considers resource availability and capacity across the provider network, as well as dependencies and compatibility between requested resources. Quality of service requirements, such as latency, throughput, and reliability, are factored into the prioritization process to ensure that demanding requests are given appropriate priority. Additionally, the algorithm takes into account the resource sharing history of both requesting and provider devices, promoting fairness and encouraging active participation in the network. By evaluating these diverse factors, the prioritizer generates a dynamic, optimized queue that adapts to the evolving needs and constraints of the resource allocation landscape.

In an embodiment, the requirements in requirements queue 524 may be arranged based on priority. Priority may be determined based on different criteria including, but not limited to, severity/urgency of a requirement, type of requirement, requesting device's 512A involvement within the sharing arrangement, such as length of registration or historical processing activity. In some embodiments, prioritizer 518 may consider other factors such as the amount required in each requirement request in requirements queue 524, the date on which the requirement request was received, or other pertinent data.

Prioritizer 518 may determine the order in which requirements should be processed or tasks should be executed. Prioritizer 518 may assign scores or weights 542 for different parameters associated with the request and compare the scores of different parameters in requirements requests to generate prioritized queue 530. Prioritizer 518 enables allocation engine 520 to make efficient and fair allocation of resources to requirements.

In an embodiment, weights 542 may be assigned to parameters including, but not limited to, importance, timelines, medical diagnoses, descriptions, fair price for a task (medical), or historical data of requesting devices 512A and ranking associated with requesting devices 512A. Quantifying and adding weights to parameters helps prioritizer 518 in decision-making and analysis. In an embodiment, the parameters to be assigned weights 542 may selected such that the assignment of weights, and interpretation of results in a reliable and efficient prioritized queue 530.

Prioritizer 518 may prioritize received requirements based on medical diagnoses, descriptions, or categories by ordering or assigning interest or urgency level to each of the plurality of medical diagnosis entries. each request may be weighed based on parameters such as the criticality of the patient, accidents, and emergencies.

Fulfilment device queue 526 may be a list of fulfilment devices 512B that are ready-to-allocate. The resource amount for each fulfilment device 512B may be updated based on reductions or credits. Allocation computer 508 may load a list of user devices 512 that may be ready for transferring resources. Any reductions if applicable are applied to the resources once they have been loaded. Reductions occur when the number of resources ready to be transferred exceeds the total amount of requirements. The result is that the resources except for resources sent to an allocation organization for administrative overhead may be reduced by a predetermined percentage. Credits may also be applied to the resources along with the reduction. Credits may also be applied to resources to reward certain behaviors, such as referring other users to the sharing organization. Both reductions and credits reduce a unit amount that a fulfilment device 512B needs to transfer as their resource. A credit reduces the unit amount of a specific user device's resource, whereas the reduction is applied to most or all resources.

In an embodiment, one or more of the fulfilment devices 512B may choose to transfer more than one resources in each period, resulting in a split resource allocation. In an embodiment, a split resource allocation parameter may be used for a user device willing to transfer multiple resources. Allocation engine 520 generates many smaller resources based on the split resource allocation parameter corresponding with the number of resources a fulfilment device 512B may be willing to spend. A split calculator may generate a split resource allocation and adjust the resource amount accordingly, so the two resources may be of unequal amounts but will add up to the same unit amount as a single resource for that user device. For large resource groups, there may be a configurable maximum resource unit amount that will automatically force a resource to be split, such that the resource amount of each split resource allocation does not exceed the maximum resource unit amount. There may be a configurable minimum resource unit amount that will automatically prevent a resource from being split or further split, such that the resource amount of each split resource allocation does not exceed the minimum resource unit.

Further, each of the fulfilment devices 512B may also be associated with a ranking. Each of the fulfilment devices 512B may be attributed with an engagement rating based on their history of engagement with the peer-to-peer sharing system and the time required by fulfilment devices 512B to transfer resources. Fulfilment device 512B with a fast engagement rating can be matched with requirements that are more serious with a higher unit value. This may assist in the quicker transfer of resources to requesting devices 512A. Further, by mapping medical diagnosis entries to affinity indicators of requesting device 512A, the fulfilment device 512B that is transferring resources may be more personally engaged in the sharing process.

Allocation engine 520 may be configured to match resources being transferred by fulfilment device 512B to requirements received from requesting devices 512A and allocate available resources from fulfilment devices 512B. Allocation engine 520 may perform allocation periodically upon the availability of requirements submitted for the previous period. The period may be commonly a monthly period, but could also be annually, quarterly, weekly, daily, or hourly depending on the number of user devices 512, regularity of requirements, size of requirements, and the requirements for prompt reimbursement. The number and amount of resources available to meet the requirements may be affected by the number of user device 512 participating, the amount of each user device resource, the deferment of a portion of the resources to the organization for administrative costs, and user device credits. In an embodiment, allocation computer 508 may be configured to balance the resources and requirements and to match each resource with a requirement.

In an embodiment, affinity-based allocation may be used to preferentially match fulfilment devices 512B with requesting devices 512A based on one or more criteria. The affinity-based allocation may be applied by a distribution algorithm responsible for computing a peer-to-peer sharing arrangement for a plurality of user devices 512. Further, while processing affinity-based allocation a ranking associated with each of the affinity indicators 532 may be used. In some embodiments, the ranking of affinity indicators 532 may be ranked by allocation engine 520. Further, in some cases, affinity indicators 532 may be ranked in order of priority by users of the respective user devices 512.

Affinity indicators 532 may include details related to an associated user such as identification, location, and address. Although only a few affinity indicators are depicted and discussed in FIG. 5, additional affinity indicators may be generated based on user information available in public information. Further, in some cases, the number of affinity indicators to be used for affinity matching may be restricted for faster processing.

Affinity indicators 532 may be related to an associated user's demographic, medical information, interests, and preferences. In an embodiment, affinity data may further include an associated user's hobbies, social networks, preferences, type of requirements, and so on. Affinity indicators 532 may include but are not limited to, location 534, requirement type 538, household demographics 536, derived affinity 528, unit type and transfer preferences 540, or religious or other group affiliations. Location 534 may be associated with the geo-location of a user device 512. In some cases, user device 512 may be configured to report location information. Household demographic 536 may include information related to age, race, ethnicity, gender, marital status, income, education, and employment of associated users.

In another embodiment, an affinity indicator may be received from a user. For example, ranked medical preferences that are significant to the associated user may be received at allocation computer 508 from the user devices 512 via an online account portal.

In one embodiment, derived affinity 528 is a type of affinity indicator derived by an AI model inference. User-related data may be accessed by the AI model inference to determine derived affinity 528. In an embodiment, data from affiliations to different activities, groups, and causes may become additional affinity indicators used for affinity matching. In another example, a user living in Ann Arbor, MI may be traveling to Montana to meet family and may meet a medical service provider in Montana occasionally. This information allows the AI model to identify Montana as an additional location affinity indicator 532.

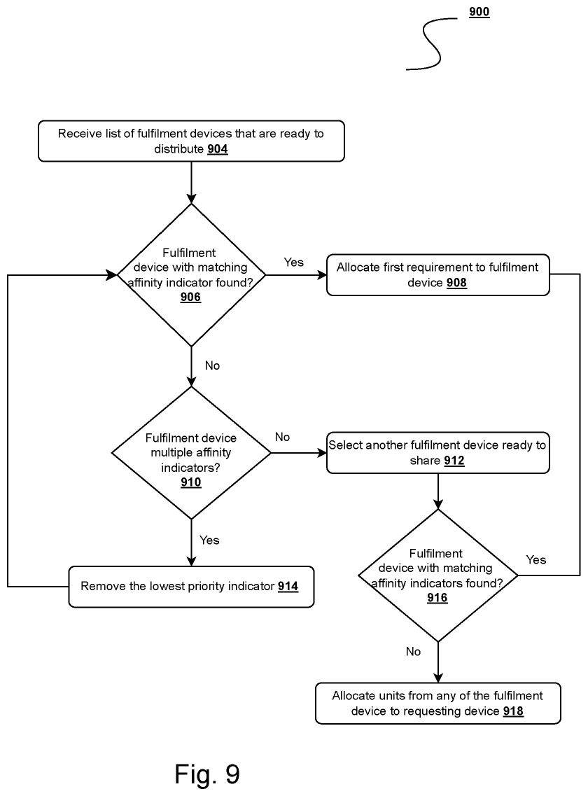

For each requirement in prioritized queue 530, allocation engine 520 may run a matching algorithm that evaluates the compatibility between the affinity indicators of requesting devices 512A and the affinity indicators of fulfilment devices 512B. The matching of affinity indicators between fulfilment devices 512B and the affinity indicators of requesting devices 512A. The process of matching affinity indicators is described in FIG. 9.

In an embodiment, allocation engine 520 may be software generated using programming languages like Python, Java, and C++, or specialized optimization software tools like CPLEX, Gurobi, or Google OR-Tools. In some embodiments, data models may be used to represent requests, fulfilment devices, affinity matching criteria, and prioritization criteria. Data structures may be used to manipulate the data in data models.

Unit type and online transfer preferences 540 may be configured to store various transfer services and currencies supported by allocation computer 508. Online transfer services include peer-to-peer unit exchange applications and web portals. User devices 512 may be set up for online transfer service. Once a fulfilment device 512B is allocated to a requesting device 512A, the fulfilment device 512B that may be ready to transfer resources may receive an online resource slip enabling transferring resources electronically to request user device 512. In an embodiment, a graphical online resource slip with a plurality of clickable links may be transmitted by allocation engine 520 to one or more fulfilment devices 512B for transferring resources to one or more requesting devices 512A. The clickable links may be associated with digital network-based solutions (e-services) that enable fulfilment device 512B to set up and transfer resources to requesting device 512A.

One or more user devices 512 may transfer resources through a preferred online transfer service using one of the pluralities of clickable links via network 310. Each of the one or more user devices 512 may select one or more preferred online transfer services for transferring and receiving resources. In some cases, the user may prefer paper checks.

FIG. 5B is a flowchart illustrating method 500B for allocating units in a peer-to-peer network, according to an embodiment of the invention. The steps of method 500B are performed by allocation computer 508.

The combination of allocation engine 520 and prioritizer 518 enables efficient allocation of resources and fulfilment of requirements based on priorities and availability of fulfilment devices 512B that are ready-to-allocate. Steps 550, 552, and 554 may be performed by prioritizer 518 and steps 556, and 558, by allocation engine 520.

At step 550, method 500B begins with receiving requests from requirement queue 524. Requirements queue 524 may be a list of requirements received, by allocation computer 508 from one or more user devices 512 for a specific period. Each requirement may be given a unique requirement identification number and may be associated with a requesting device 512A. The requirement received may further include a description of the requirement, associated user number, associated user ID identifying a particular associated user within the arrangement having a requirement, and, in some embodiments, a quantity associated with the requirement.

At step 552, allocation computer 508 may use a prioritizing algorithm (i.e. prioritizer 518) to assign weights 542 to different parameters in each of the requests. In an embodiment, weights 542 may be assigned to parameters including, but not limited to, importance, timelines, medical diagnoses, descriptions, fair price for a task (medical) or historical data of requesting devices 512A and ranking associated with requesting devices 512A.

Prioritizer 518 may maintain a priority queue or a similar data structure to store requirements along with their assigned priorities. The priority queue ensures that requirements with higher priorities are positioned at the front of the queue.

Quantifying and adding weights to parameters helps prioritizer 518 in decision-making and analysis. In an embodiment, the parameters to be assigned weights 542 may selected such that the assignment of weights, and interpretation of results in a reliable and efficient prioritized queue 530.

At step 554, a priority queue (i.e., prioritized queue 530) is generated by summing the weights 542 assigned to each parameter in a request and arranging the requirements from the highest weight to the lowest weight. Arranging the requirements from the highest weight to the lowest weight results in the generation of prioritized queue 530. The quantification of parameters helps prioritizer 518 in decision-making and analysis. In an embodiment, the parameters to be assigned weights 542 may be selected such that the assignment of weights, and interpretation results in a reliable and efficient prioritized queue 530.

At step 556, affinity matching is performed. A matching of affinity indicators associated with fulfilment device 512B that are ready-to-allocate with the affinity indicators of requesting devices 512A in prioritized queue 530 is performed.

In operation, affinity matching may be performed iteratively by matching each affinity indicator individually and reducing affinity indicators 532 of fulfilment device 512B in order of priority while trying to match affinities. By reducing number of the affinity indicators 532 of fulfilment device 512B, allocation engine 520 may maximize the probability of the fulfilment device queue 526 matching affinity indicators 532 of the requesting device. This type of affinity matching allows for higher chances of fulfilling requirements. For example, allocation engine 520 may first consider medical history diagnoses while performing affinity matching. However, there may be a large number of resources from fulfilment devices 512B associated with users having a cancer history but a low number of receiving members having current cancer medical bills available for matching. In that case, allocation engine 520 would match fulfilment devices 512B designated with a cancer medical diagnosis entry as an affinity indicator until all the requirements in requirements queue 524 are complete. Allocation engine 520 would proceed to a lower-ranked affinity indicator 532, such as household demographics. In this example, all the requirements would be matched with resources having corresponding household demographic entries. The demographic entries may include the size of the family, number of kids, age of kids, school going, college going, senior citizen, and so on.

At 558, an allocation decision is made. When a minimum number of fulfilment devices 512B are available, allocation engine 520 may retrieve the requirement request with the highest priority from the prioritized queue 530.

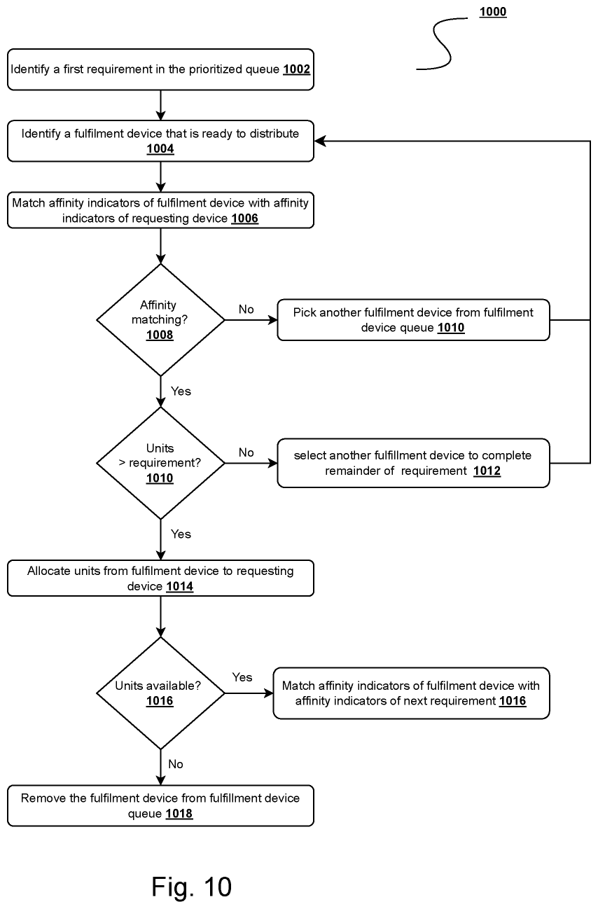

Allocation engine 520 identifies one or more fulfilment devices 512B based on the affinity-based matching performed in step 556 to fulfill the first requirement in the prioritized queue 530. The first requirement may be at the top of the prioritized queue 530. One or more fulfilment devices 512B may be allocated to requesting device 512A based on the matching between the affinity indicators 532 of the fulfilment devices 512B and affinity indicators 532 of the requesting devices 512A. FIGS. 9 and 10 describe in detail the process of affinity matching and resource allocation for fulfilling a requirement request.

Allocation of resources to the first requirement results in the generation of resource slips. With regard to resource slips, fulfilment devices 512B may be presented with online resource slips that include clickable web links for e-services, and therefore may participate in the requesting devices 512A preferred e-service.

At step 560, once the resource slips are allocated, allocation computer 508 may be configured to monitor the progress of the allocation and tracks its completion. Once the resources are received by the requesting device, the request is considered as fulfilled. At step 560, when the request is met, then at step 562, the prioritized queue 530 is updated.

At step 560, when the request has not been allocated with resources from a fulfilment device, allocation computer 508 may add the first requirement back to the prioritized queue 530. Allocation computer 508 determines whether a pre-defined time assigned to complete the first requirement has elapsed. When the pre-defined time assigned to complete the first requirement has elapsed and the requirement has not been fulfilled, allocation engine 520 may add the requirement back to the prioritized queue 530.

Further, in some embodiments, prioritizer 518 may dynamically update the priorities of requirement requests in prioritized queue 530 based on changing circumstances or new information. Allocation engine 520 adapts to the changes in priority and allocation decisions are adjusted accordingly. There is a continuous collaboration between allocation engine 520 and prioritizer 518. The collaboration between the prioritizer 518 and allocation engine 520 ensures requirement requests are executed in order of their priorities, optimizing utilization of fulfilment devices and minimizing wait times for high-priority requirements. Further, this collaboration ensures that critical tasks or requests are given precedence and resources from fulfilment devices are utilized effectively.

### Detailed Description of Exemplary Embodiments

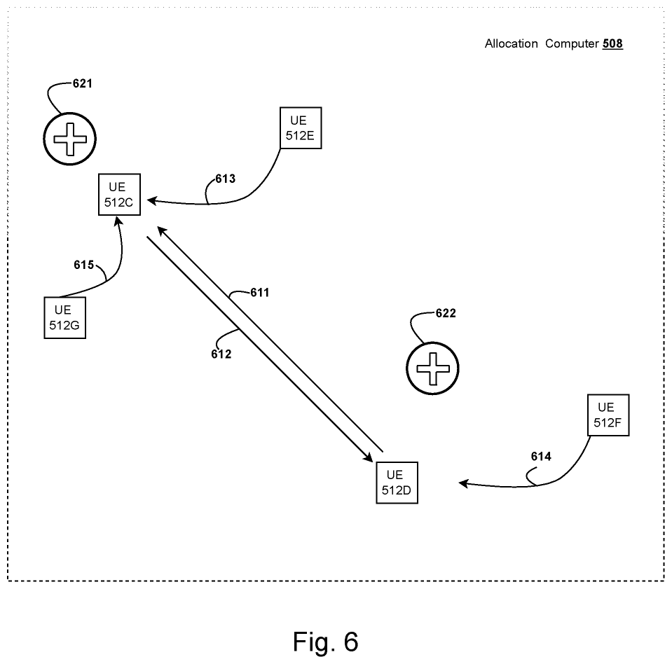

FIG. 6 depicts an example illustration of a peer-to-peer allocation system, according to an embodiment of the invention; An allocation arrangement may be enabled between any of the user devices 512C-512G.

In an embodiment, allocation computer 508 may receive a ready-to-allocate indication from some of the fulfilment user devices 512 among user devices 512C-512G, and allocation computer 508 may receive requirements from other user devices among user devices 512C-512G. Allocation computer 508 may enable sharing between one or more fulfilment devices and requesting devices.

Allocation computer 508 may receive a requirement in the form of a medical need 621 from user device 512C. Similarly, allocation computer 508 may receive a requirement in the form of a medical need 622 from user device 512D. For example, user devices 512C and 512D may be requesting user devices that may be associated with requirements. Based on affinity parameters (also referred to as affinity indicators 532), a match may be performed between fulfilment devices and requesting user devices.

Allocation computer 508 may transmit a graphical online resource slip with a plurality of clickable links that allow fulfilment devices to transfer resources to receiving user devices 512 via digital network-based solutions (e-services). Allocation computer 508 may transmit a graphical online resource slip with a plurality of clickable links to user device 512D to enable user device 512D to transfer a resource 611 to user device 512C. Allocation computer 508 may transmit a graphical online resource slip with a plurality of clickable links to user device 512D that enables user device 512D to transfer resource 611 to user device 512C. Allocation computer 508 may transmit a graphical online resource slip with the plurality of clickable links to user device 512E that enables user device 512E to transfer resource 613 to user device 512C. Allocation computer 508 may transmit a graphical online resource slip with a plurality of clickable links to user device 512G that enables user device 512G to transfer resource 615 to user device 512C.

Therefore, the sharing arrangement enabled by allocation computer 508 assists users associated with requesting user devices 512C and 512D to manage their requirements (e.g. sharable of medical expenses) with the units they receive from sharing user devices 512. Each of the fulfilment devices may bear a portion of the requirements 621, and 622.

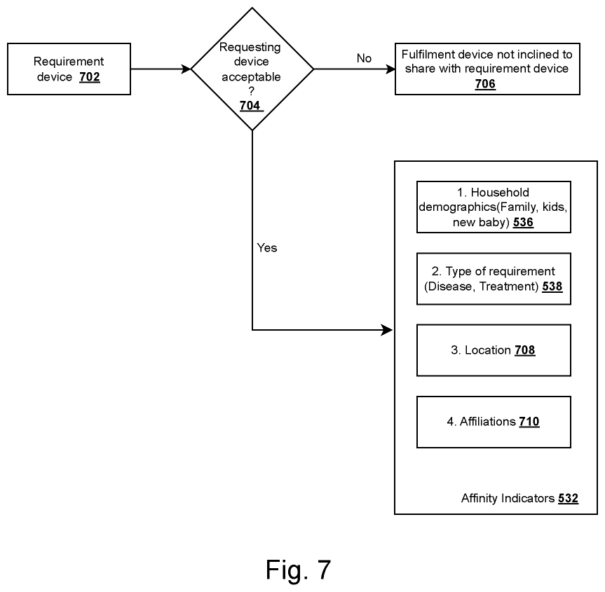

FIG. 7 illustrates affinity indicators of a fulfilment device 512B used for affinity matching for a requirement request, according to an embodiment of the invention. Allocation engine 520 on receiving a requirement request 702 may identify a fulfilment device 512B from the fulfilment device queue 526. Allocation engine 520 may then determine, at step 704, if the requesting device 512A from which the requirement request 702 is acceptable. In an embodiment, fulfilment device 512B may include anti-affinity data. Anti-affinity data refers to certain affinities that are unacceptable to user of the fulfilment device 512B. This may be opposite to affinity indicators 532. In a case where anti-affinity indicators are present in the affinity of the requesting device, then, at step 706, the fulfilment device 512B may not be inclined to allocate resources with the requesting device 512A. However, if no anti-affinity parameter is found, allocation engine 520 continues to match affinity indicators 532 of the fulfilment device 512B with affinity indicators 532 of requesting device 512A. Various affinity indicators 532 may include household demographics 536, requirement type 538, location 708, and affiliations 710. The geographic location from which the requirement requests 702 is received may be compared to the geographic location favored by a user of the fulfilment device 512B. Affiliations 710 may include associations with common groups, parties, companies, causes, and so on. Affinity indicators 532 listed in FIG. 7 may be listed as per the importance of the fulfilment device 512B. Further, affinity indicators 532 may be generic as listed or may include additional preferences specific to the fulfilment device 512B.

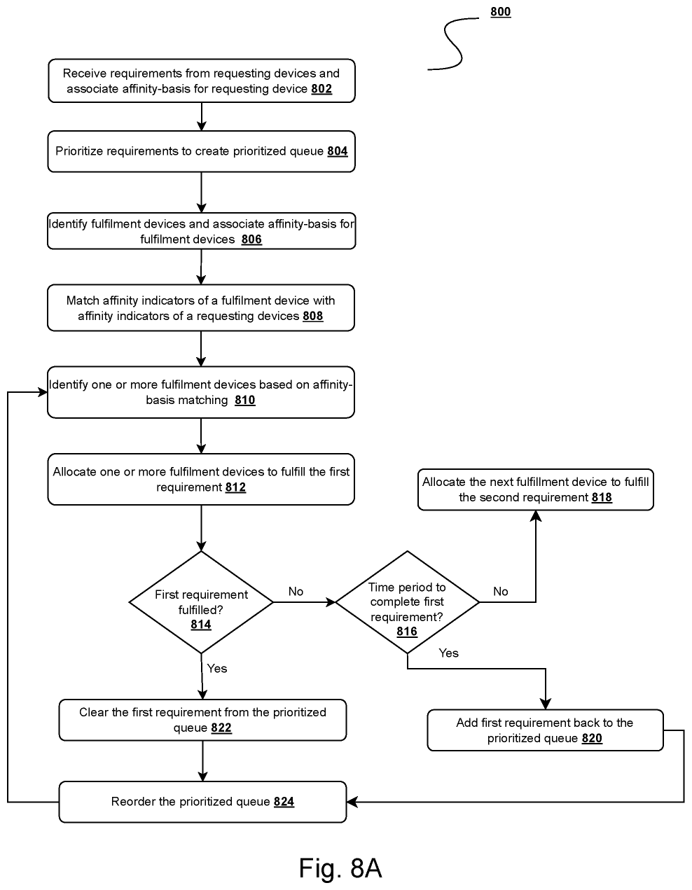

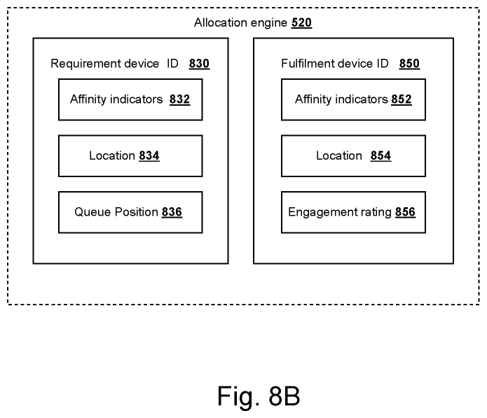

FIG. 8A is a flowchart depicting method 800 for allocating resources to requirements from between user devices 512, according to an embodiment of the invention. In step 802, allocation computer 508 may receive requirements from requesting device 512A and determine affinity indicators 532 associated with the requesting device 512A. In an embodiment, affinity matching may be performed by comparing affinity indicators 532 associated with requesting devices 512A with affinity indicators 532 associated with fulfilment devices 512B. Each requirement request may be given a unique need identification number. Requirements received may further include a description of the need, and a user device ID identifying specific user device 512.

In step 804, prioritizer 518 of allocation computer 508 may be configured to prioritize the received requirements to create a prioritized queue 530. The prioritization may be based on parameters including, but not limited to severity of a need, type of need, requesting devices 512A involvement within the sharing service, such as length of association or timeliness of transferring resources. In some embodiments, prioritizer 518 may consider other factors such as the amount required in each need request in requirements queue 524 or the date on which the need request is received. Prioritized queue 530 may be iteratively updated based on the receipt of requirements from requesting devices 512A. In some cases, requirements queue 524 may be filtered to fulfill requirements based on a, for example, cut-off related to the date of receipt of the request. In some cases, requirements may be prioritized based on an urgency level.

Prioritization can be based on total requirements affiliated with a particular affinity indicator 532. Prioritization can be based on a desired efficiency, for example: first electronic resource transfer and then non-electronic resource transfer may be matched based on proximity to minimize postage transportation time. Prioritization may be configured to increase user device engagement, or by prioritizing matching based on different factors. The prioritization may be determined based on common sponsorship, allowing a third party to influence the prioritization of matching based on the third party's preference.

In step 806, allocation engine 520 may identify fulfilment devices 512B that are ready-to-allocate. Fulfilment devices 512B may present in fulfilment device queue 526 and may include user devices 512 that indicate readiness to perform sharing transmission. In an embodiment, affinity indicators 532 may be associated with fulfilment devices 512B.

At step 808, allocation engine 520 may be configured to match the affinity indicators 532 associated with fulfilment devices 512B with the affinity indicators 532 associated with requesting devices 512A present in prioritized queue 530. In one embodiment, allocation engine 520 may address urgent requirements first followed by special requirements. In some cases, allocation engine 520 may use a specific requirement type 538 as the basis for performing the matching between affinity indicators 532 of fulfilment device 512B and affinity indicators 532 of requesting devices 512A. Further, each of the affinity indicators 532 may be ranked. Affinity indicators 532 may include but are not limited to, location 534, requirement type 538, household demographics 536, unit type and transfer preferences 540, or religious or other group affiliations. For example, a healthcare sharing organization may agree to always allocate resources associated to medical bills of an employee of a specific organization with other employees of the same organization. In such a case, allocation engine 520 may process the employer group entries corresponding to the same organization and this may act as the primary affinity indicator 532 while allocating resources from fulfilment device queue 526.

In operation, allocation engine 520 may allocate one or more fulfilment devices 512B by iteratively reducing affinity indicators 532 of fulfilment device 512B in order of priority while trying to match affinities. By reducing number of the affinity indicators 532 of fulfilment device 512B, allocation engine 520 may maximize the probability of the fulfilment device queue 526 matching affinity indicators 532 of the requesting device. This type of affinity indicator-based matching along with prioritization of requests allows for higher chances of fulfilling requirements. For example, allocation engine 520 may first consider medical history diagnoses while performing affinity matching. However, there may be a large number of resources from fulfilment devices 512B associated with users having, for example, a cancer history but a low number of receiving members having, for example, current cancer medical bills available for matching. In that case, allocation engine 520 would match fulfilment devices 512B designated with, for example, a cancer medical diagnosis entry as an affinity indicator 532 until all the requirements in requirements queue 524 are complete. Allocation engine 520 would proceed to a lower-ranked affinity indicator 532, such as household demographics. In this example, all the requirements would be matched with resources having corresponding household demographic entries. The demographic entries may include the size of the family, number of kids, age of kids, school going, college going, senior citizen, and so on.

Alternatively, in some embodiments, allocation engine 520 could process the secondary affinity indicator 532 iteratively based on the total requirement units associated with each of the secondary affinity indicator 532. In this example, allocation engine 520 creates a total for each of the secondary affinity indicators 532. Allocation engine 520 selects a first secondary affinity indicator 532 based on requirements in requirements queue 524 having the greatest total required amount. Allocation engine 520 proceeds to match fulfilment device 512B from the fulfilment device queue 526 which corresponds to the selected secondary affinity indicator. Once allocation engine 520 has satisfied all the requirements from the requirements queue 524 corresponding to the first selected secondary affinity indicator 532, allocation engine 520 may proceed to requirements in the requirements queue 524 corresponding to the second selected secondary affinity indicator 532. In an embodiment, the second selected secondary affinity indicator 532 may include a second greatest total required amount. Allocation engine 520 proceeds to match resources from the fulfilment device queue 526 with requirements from requirements queue 524 based on affinity matching and maximizes the number of fulfilment devices 512B that may be affinity matched to requesting devices 512A.

In one embodiment, allocation engine 520 may first match resources from fulfilment devices 512B that have elected to transfer resources electronically with requirements from requesting devices 512A that may have elected to receive resources electronically. For example, fulfilment devices 512B which prefer electronically transferred resources, and allocation engine 520 would perform affinity-based allocation based on the type of medical need. Allocation engine 520 may proceed to match resources from the fulfilment device queue 526 with requirements from user devices 512 who, for example, have not elected to receive resources electronically. For fulfilment devices, that prefer non-electronically transferred resources, allocation engine 520 may perform an affinity-based allocation based on geographic proximity.

In another embodiment, third parties can request that user devices 512 (both fulfilment and requesting) associated with an organization be preferentially matched. For example, an organization or a third party (such as a news magazine or a host conference) may reinforce its community perception and affiliation with an allocation organization by sponsoring an affinity-based allocation. The online resource slip can display “This month, you're sharing with a fellow XYZ conference attendee.”

In step 810, allocation engine 520 identifies one or more fulfilment devices 512B based on the affinity-based matching performed in step 808 to fulfill the first requirement in the prioritized queue 530. The first requirement may be at the top of the prioritized queue 530. One or more fulfilment devices 512B may be allocated to requesting device 512A based on the matching between the affinity indicators 532 of the fulfilment devices 512B and affinity indicators 532 of the requesting devices 512A. FIGS. 9 and 10 describe in detail the process of affinity matching and resource allocation for fulfilling a requirement request.

In step 812, allocation engine 520 may allocate one or more fulfilment devices 512B to the first requirement in the prioritized queue 530. Allocation of resources to the first requirement results in the generation of resource slips. Resource slips may be printed resource slips or online resource slips. In the case of online resource slips, fulfilment devices 512B may be presented with online resource slips that include clickable web links for e-services, and therefore may participate in the requesting devices 512A preferred e-service.

At step 814, once allocation has been completed and resource slips have been generated and provided to fulfilment devices 512B, allocation engine 520 may be configured to determine if the first requirement has been fulfilled. When requesting device 512A receive one or more resources from fulfilment device 512B, the first requirement may be considered fulfilled and completed.

When it is determined that the first requirement has been fulfilled, allocation engine 520 at step 822 may clear the first requirement from the prioritized queue 530. On clearing the first requirement from the prioritized queue 530, allocation engine 520 may reorder the prioritized queue 530 at step 824.

When it is determined that the first requirement has not been fulfilled, allocation engine 520 at step 816 determines whether the pre-defined time assigned to complete the first requirement may have elapsed. When the pre-defined time assigned to complete the first requirement has not elapsed, then at step 818 allocation engine 520 begins to allocate resources to fulfill the second requirement from the prioritized queue 530.

When a pre-defined time assigned to fulfill the first requirement has elapsed and the first requirement has not been fulfilled, then at step 820, allocation engine 520 may add the first requirement back into the prioritized queue 530. As the first requirement was the top priority it may be moved to the top of the prioritized queue 530, and allocation engine 520 may perform allocation again at step 812 for the first requirement. Allocation engine 520 may be concurrently performing matching of affinity indicators 532 of ready-to-allocate fulfilment devices 512B and requesting devices 512A present in the prioritized queue 530.

FIG. 8B illustrates information used by allocation engine 520 to determine and allocate fulfilment devices 512B for requirements, according to an embodiment of the invention. At any given instance, allocation engine 520 may be configured to use fulfilment device 512B information to identify requesting devices 512A that match affinity indicators 532 of fulfilment device 512B. To perform a match between affinity indicators 532 of a requesting device 512A and fulfilment device 512B, allocation engine 520 may consider different factors. For example, affinity indicators 852 associated with fulfilment device 512B may be matched with affinity indicators 832 of requesting device 512A. The process of affinity indicator matching is discussed in detail in FIG. 9. In addition to considering affinity indicators 532, location 854 associated with fulfilment device 512B may be matched with location 834 associated with requesting device 512A. User devices with a GPS in a same geographic location may be more inclined to allocate resources with user devices of the same or nearby geolocation. In some cases, allocation engine 520 may consider queue position 836 of the requirement in the prioritized queue 526. Although the highest priority requirements may be processed first, other requirements may be allocated resources based on matching of the affinity indicators 532 of fulfilment devices 512B with requesting devices 512A in the prioritized queue 530.

FIG. 9 is a flow diagram illustrating method 900 for affinity matching used in allocation, according to an embodiment of the invention. The steps of method 900 may be performed by allocation engine 520. At step 904, allocation engine 520 may start affinity matching between fulfilment devices 512B that are ready-to-allocate with the requesting devices 512A in prioritized queue 530. At any given instance of time, fulfilment device queue 526, may list a set of ready-to-allocate fulfilment devices 512B. In some cases, requirements that are urgent or special are considered while performing the matching. Further, in some embodiments, allocation engine 520 may select a requirement type 538 while performing the match.

At step 906, allocation engine 520 may determine if affinity indicators associated with the fulfilment device 512B match against the affinity indicators of the requesting device 512A. When the affinity indicators match, then at step 908, allocation engine 520 may allocate the requirement to the fulfilment device 512B. In an embodiment, a graphical online resource slip with a plurality of clickable links may be transmitted by allocation engine 520 to one or more fulfilment devices 512B for transferring resources to one or more requesting devices 512A. The clickable links may be associated with digital network-based solutions (e-services) that enable fulfilment devices 512B to set up and transfer resources to requesting devices 512A. Resource allocation to fulfil the first requirement is discussed in detail in FIG. 10.

When the affinity indicators do not match, allocation engine 520, at step 910, may determine if the fulfilment device 512B has multiple affinity indicators 532. When the fulfilment device 512B does not have other affinity indicators 532, then, at step 912, allocation engine 520 may select a new fulfilment device 512B. At step 916, allocation engine 520 may determine if the fulfilment device with affinity indicators 532 if mappings to the affinity indicators 532 of the requesting device 512A are found. When a fulfilment device 512B is found with affinity indicators matching with the requesting device 512B affinity indicators, then allocation engine 520 may allocate the requirement to the fulfilment device 512B. However, when there are no fulfilment devices 512B with matching affinity indicators, the allocation engine 520, at step 918 may allocate a random fulfilment device 512B from the list of fulfilment devices that are ready-to-allocate.

When multiple affinity indicators 532 are present, then at step 814, the lowest affinity is removed at step 914. Method 900 goes back to affinity matching at step 906.

The affinity matching process depicted in FIG. 9 may be a critical component of the resource allocation system, enabling efficient and precise matching of resource requests to provider devices. This process is operable to accommodate an expanded quantity of resources, which encompass a wide range of resource types, including computational resources, data resources, digital assets, and more (see above). The affinity indicators used in the matching process are operable to include resource-specific attributes such as compatibility, performance requirements, and allocation history. These indicators provide a comprehensive view of the characteristics and constraints associated with each resource request and provider device.

The allocation engine leverages these enriched affinity indicators to perform a multi-dimensional comparison between the requirements of each resource request and the capabilities of available provider devices. The matching algorithm iteratively traverses the hierarchy of affinity indicators, starting with the highest-priority indicators and progressively refining the search space. At each step, the algorithm evaluates the compatibility and suitability of provider devices based on the current set of affinity indicators, and may filter out devices that do not meet the necessary criteria.

This iterative process allows the allocation engine to efficiently narrow down the pool of potential provider devices, considering factors such as resource type, compatibility, capacity, and quality of service requirements. By systematically comparing affinity indicators and applying successive filters, the matching process identifies the optimal set of provider devices for each resource request.

The enhanced affinity matching process empowers the resource allocation system to make intelligent and precise matches between requesting devices and provider devices, ensuring that the right resources are allocated to the right requests in a timely, efficient, and prioritized manner. This advanced matching capability is essential for handling diverse and complex resource requirements present in modern technical environments, from distributed computing and data analytics to digital asset management and beyond.

FIG. 10 is a flowchart illustrating a method 1000 of allocating resources for a requirement, according to an embodiment of the invention. The steps of method 1000 may be performed by allocation engine 520. At any given instance, a list of available fulfilment devices 512B and a list of requirements in prioritized queue 530. Allocation engine 520 may perform allocation periodically upon the availability of requirements submitted for the previous period. The period may be monthly, but could also be annually, quarterly, weekly, daily, or hourly depending on the number of user devices 512, regularity of requirements, size of requirements, and the requirements for prompt reimbursement. The number and amount of resources available for sharing to meet the requirements may be affected by the number of user device 512 participating, the amount of each user device resource, a deferment of a portion of the resources to the organization for administrative costs, user device credits, or other factors. In an embodiment, allocation computer 508 may be configured to balance resources and requirements and to match each resource with a requirement.

At step 1002, allocation engine 520 may identify a first requirement in the prioritized queue 530. After prioritization, a topmost requirement may be considered a first requirement.

At step 1004, allocation engine 520 may select a fulfilment device 512B that is ready-to-allocate. The fulfilment device 512B may be any user device 512 in the fulfilment device queue 526. Each resource may be associated to a collection of units, the units may refer to at least a portion of computational resources, data resources, digital assets, services, virtual resources, network resources, and the like. In one embodiment, each resource may be associated with a specific amount of units. Units may be used for fulfilling one or more requirements. Further, each fulfilment device 512B may support more than one resource or more than one type of resource.

At step 1006, allocation engine 520 may perform affinity matching between affinity indicators 532 associated with fulfilment device 512B and affinity indicators 532 associated with requesting devices 512A.

At step 1008, allocation engine 520 may determine if affinity indicators are matching.

The affinity matching may be performed using the steps discussed in method 900. When there is no affinity matching between the fulfilment device 512B and the requesting device 512A, then at step 1010, allocation engine 520 may pick another fulfilment device 512B from fulfilment device queue 526.

At step 1008, when affinity matching is successful, allocation engine 520 may determine if the units being provided by fulfilment device 512B may be greater than the units required in the first requirement. In an embodiment, a check may be performed to determine if the fulfilment device 512B has enough associated units to fulfill the resources in the requirement. In cases where the fulfilment device 512B does not have enough units, the requirement may be split so that two (or more) different fulfilment devices 512B complete the requirement. At step 1012, allocation engine 520 may decide that the resource required to complete the first requirement may be split and another fulfilment device 512B is required to supply the part of the resource.

At step 1014, when affinity-matching is successful, allocation engine 520 may allocate one or more resources from the fulfilment device 512B to the required device. Once a resource is allocated to a requesting device 512A, one or more of the fulfilment devices 512B that may be ready to transfer resources may receive an online indicium (herein also referred to as a resource slip) for enabling a transferring of resources electronically to requesting device 512A. In an embodiment, a graphical online resource slip with a plurality of clickable links may be transmitted by allocation engine 520 to one or more fulfilment devices 512B for transferring resources to one or more requesting devices 512A.

At step 1016, allocation engine 520 may perform a check to determine if the fulfilment device 512B is ready-to-allocate more. In some cases, fulfilment devices 512B may have (or be left with) more units to support additional requirements. Additional units can be used to support another requirement that matches the affinity indicator 532 of the fulfilment device 512B. At step 1016, allocation engine 520 may be configured to match the affinity indicator 532 of the fulfilment device 512B with the indicator 532 of the next requirement in the prioritized queue 530.

At step 1018, allocation engine 520 may remove the fulfilment device 512B from fulfilment device queue 526 when the fulfilment device 512B is not able to allocate more resources. When the fulfilment device 512B does not have any leftover units to support a resource allocation, the fulfilment device 512B is deleted from the list of ready-to-allocate fulfilment devices queue 526.

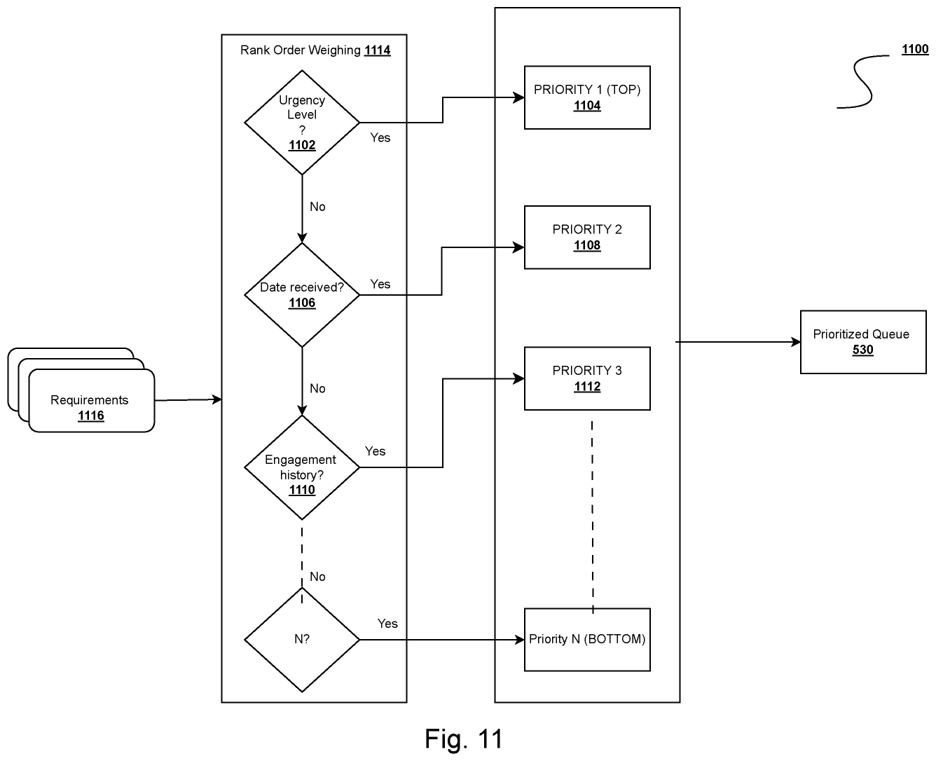

FIG. 11 depicts a flowchart of method 1100 for rank order-based weight assignment for the generation of prioritized queue 530, according to an embodiment of the invention. The steps of method 1100 are performed by prioritizer 518 to rank the order of weight assignment to each parameter based on its relative importance. In an embodiment, prioritizer 518 is configured to generate a prioritized queue 530 for a subset of requirements from requirements queue 524. In an embodiment, prioritizer 518 is configured to generate a prioritized queue 530 for all the requirements from requirements queue 524.

Parameters considered may include medical diagnoses, descriptions, or categories by ordering or assigning interest or urgency levels to each of the plurality of medical diagnosis entries. Examples of requests include criticality of the patient, accidents, and emergencies.

Each parameter associated with each request may be assigned a weight. The sum of all weights should typically equal 1 or 100. Based on the weight assignment, priority levels are computed and the prioritized queue 530 may be generated. At step 1102, allocation engine 520 may perform a check to determine if there is any urgency associated with the request. In case the request is urgent it becomes the topmost priority 1104. In some cases, urgent requests may have different levels based on the criticality of the patient, treatment timeline, a timeline of treatment, fair price sought for the treatment, prepayment requirement, and so on. If it is not an urgent request, allocation engine 520 at step 1106, may check the date on which the requirement was received. Priority may be given to the earliest received request. The receipt date may become the second priority 1108. If receipt dates match, allocation engine 520, at step 1110 may check the engagement history of the requesting device 512A. Priority may be given to requesting device 512A which has a long history in the sharing portal. Although FIG. 11 illustrates only three parameters and corresponding priorities, multiple parameters and corresponding priorities may be used for generating prioritized queue 530 of requirements.

In some embodiments, prioritizer 518 may consider other factors such as the resources required in each need request in requirements queue 524 or the date on which the need request is received. The prioritized queue 530 may be generated for a set of requirements received during a collection timeframe. In an example, the requirements queue 524 may be filtered to fulfill requirements based on the cut-off related to the date of receipt of the request. All requests may be processed by prioritizer 518 and assigned weights based on rank-order weighting.

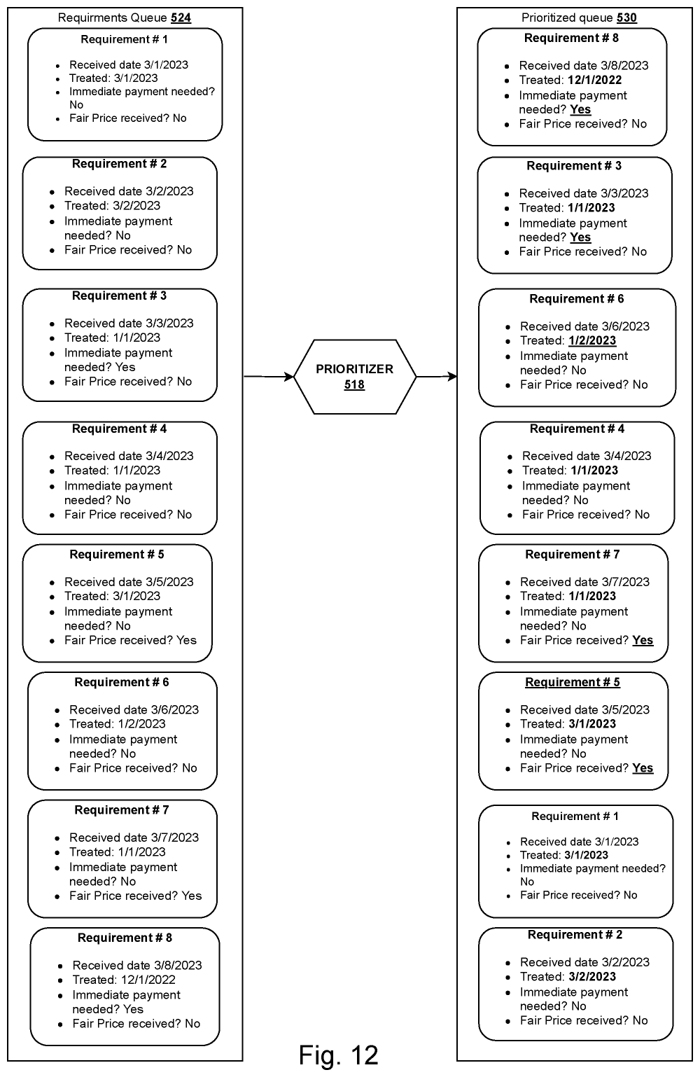

FIG. 12 illustrates an example of requirements received from requesting devices 512A being prioritized by the prioritizer 518, according to an embodiment of the invention. Allocation of resources may be performed once the requests are prioritized. Requirements in the requirements queue 524 are processed by prioritizer 518 to generate prioritized queue 530. Requirements queue 524 may include a list of requirements numbered, for example, 1-8 that are received from requesting devices 512A. For example, requirements may be medical bills associated with requesting devices 512A.

Prioritizer 518 may be configured to generate and maintain prioritized queue 530 for the requirements received based on the priority given to parameters such as urgency, fair prices, treatment date, data or received, and other parameters present in the received requirement request. Prioritization may be performed using method 1100 as described in FIG. 11. Requirements 8 and 3 may be given higher priority based on urgency and date of treatment. The rest of the requirements may be arranged based on the treatment date. Prioritized queue 530 lists the received requirements in order of priority.

The skilled person will be aware of a range of possible modifications of the various embodiments described above. Accordingly, the present invention is defined by the claims and their equivalents.

What is claimed is:

1. A peer-to-peer affinity-based resource allocation system, comprising:
an allocation computer comprising a memory, a processor, and a plurality of programming instructions stored in the memory, which when executed by the processor, cause the processor to:
establish a peer-to-peer network connection with a plurality of user devices;
receive and store resource requests from a plurality of requesting devices among the user devices via the peer-to-peer network connection during a collection timeframe, wherein each requesting device is associated with a set of affinity indicators;
generate a prioritized queue of the received resource requests by applying a weighted prioritization algorithm to the affinity indicators associated with each requesting device;
identify a plurality of provider devices among the user devices that are available to provide resources, wherein each provider device is associated with a set of affinity indicators; fulfill a highest priority resource request in the prioritized queue by:
iteratively comparing the affinity indicators of each provider device with the affinity indicators of the requesting device associated with the highest priority resource request using a matching algorithm;
allocate resources from a first provider device to the requesting device based on the affinity matching, wherein the allocation triggers a secure transfer of resources from the first provider device to the requesting device via the peer-to-peer network connection;
monitor the status of the resource transfer and update the prioritized queue based on the completion of the transfer within a predefined timeframe.

2. The system of claim 1, wherein the plurality of programming instructions when further executed by the processor, cause the processor to:
determine whether the resources available from the first provider device are insufficient to fulfill the highest priority resource request;
responsive to determining the insufficiency, identify a second provider device with matching affinity indicators using the iterative comparison;
split the resource allocation between the first provider device and the second provider device; and
securely allocate resources from both the first provider device and the second provider device to the requesting device via the peer-to-peer network connection.

3. The system of claim 2, wherein perform the iterative comparison of affinity indicators the plurality of programming instructions when further executed by the processor, cause the processor to:
determine whether the set of affinity indicators of the first provider device, ordered by priority, matches the affinity indicators of the requesting device;
responsive to a mismatch, removing the lowest priority affinity indicator from the set of the first provider device;
update the set of affinity indicators of the first provider device; and
repeat the comparison with the updated set of affinity indicators until a match is found or all indicators are exhausted.
